(19) United States
(12) Patent Application Publication
(10) Pub. No.: US 2012/0182368 A1
(43) Pub. Date: Jul. 19, 2012

(54) OPTICAL SCANNING DEVICE AND IMAGE FORMING APPARATUS

(75) Inventor: Takahiro KOJIMA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/346,469

(22) Filed: Jan. 9, 2012

Related U.S. Application Data
(60) Provisional application No. 61/432,467, filed on Jan. 13, 2011.

(30) Foreign Application Priority Data
Oct. 26, 2011 (JP) P2011-234577

(51) Int. Cl. B41J 2/385

(52) U.S. Cl. 347/118

(57) ABSTRACT

According to one embodiment, an optical scanning device includes a mirror with one end portion fixed as a fulcrum which includes at least a first, a second and a third surface along the longitudinal direction and reflects a scanning beam, a first support portion to support the first surface at the other end portion of the mirror, a second support portion to support the second surface of the mirror, whose position conforms to a position of the first support portion in the longitudinal direction of the mirror, a drive portion to drive the second support portion to be moved, and a third support portion to support the mirror by pressing the third surface of the mirror which is supported by the first support portion and the second support portion.

### CROSS-REFERENCE TO RELATED APPLICATION

This application is based upon and claims the benefit of priority from the prior U.S. patent application Ser. No. 61/432,467, filed on Jan. 13, 2011, the entire contents of which are incorporated herein by reference.

This application is also based upon and claims the benefit of priority from the prior Japanese Patent Application No. 2011-234577, filed on Oct. 26, 2011, the entire contents of which are incorporated herein by reference.

### FIELD

Exemplary embodiments described herein relate to an optical scanning device and an image forming apparatus.

### BACKGROUND

An optical scanning device of an image forming apparatus is known in which one end portion of a return mirror is fixed and the other end portion is moved in the reflection direction by a correction motor and which corrects the tilt of a scanning beam irradiated on a photoconductor inside the image forming apparatus. However, if the vibration at the time of operating the image forming apparatus main body is applied to the optical scanning device, a problem is generated that the vibration is transmitted to the mirror to thereby cause image fault.

### BRIEF DESCRIPTION OF THE DRAWINGS

FIG. 1 is a schematic sectional view showing an image forming apparatus in a first embodiment;

FIG. 2 is a schematic sectional view showing a printer portion of the image forming apparatus in the first embodiment;

FIG. 3 is a perspective view showing a general structure of an optical scanning device in the first embodiment;

FIG. 4 is a perspective view showing a mirror unit of the optical scanning device in the first embodiment;

FIG. 5 is a perspective view of a correction portion in the first embodiment;

FIG. 6 is a side view of the correction portion in the first embodiment;

FIG. 7 is an enlarged perspective view of the correction portion from which a mirror is removed in the first embodiment;

FIG. 8 is an enlarged perspective view of the correction portion in the first embodiment; and

FIG. 9 is a side view of a correction portion in a second embodiment.

### DETAILED DESCRIPTION

In general, according to one embodiment, there is provided an optical scanning device including a mirror with one end portion fixed as a fulcrum which reflects a scanning beam, the mirror including at least a first surface, a second surface and a third surface along the longitudinal direction; a first support portion to support the first surface at the other end portion of the mirror; a second support portion to support the second surface of the mirror, whose position conforms to a position of the first support portion in the longitudinal direction of the mirror; a drive portion to drive the second support portion to be moved; and a third support portion to support the mirror by pressing the third surface of the mirror which is supported by the first support portion and the second support portion.

Hereinafter, image forming apparatuses according to embodiments will be described with reference to the accompanied drawings.

### First Embodiment

In an optical scanning device provided in an image forming apparatus of a first embodiment, a position of a projecting portion to support a bottom surface of a mirror and a position of a projection to support a side surface of the mirror conform to each other in the longitudinal direction of the mirror.

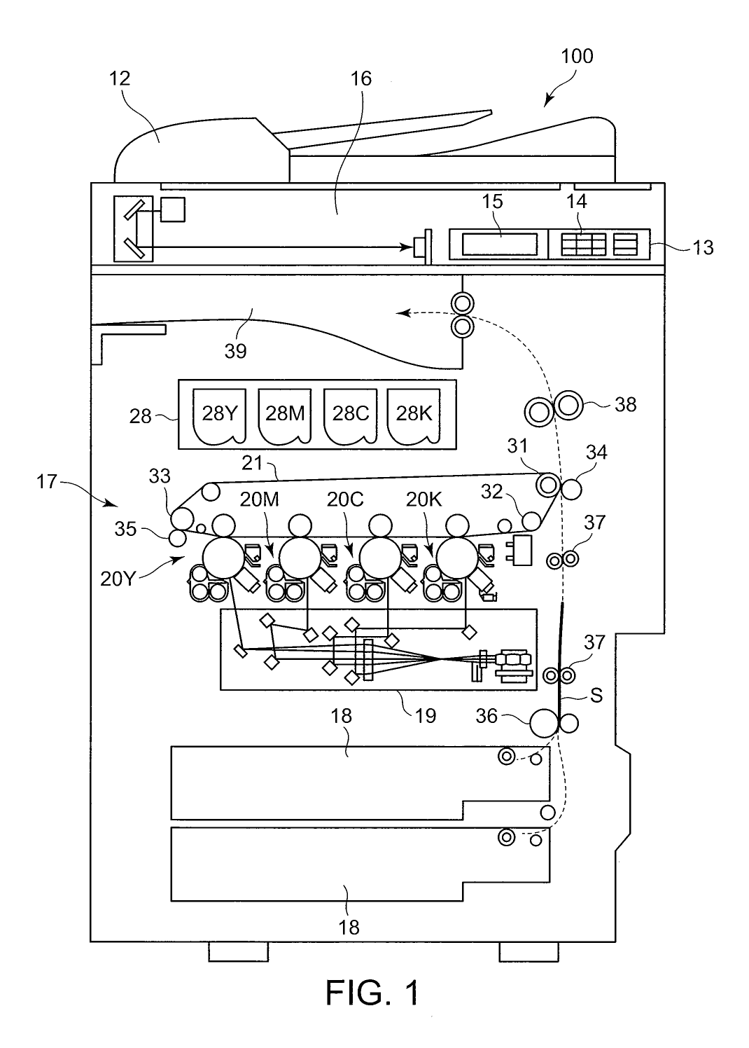

FIG. 1 is a front view of an image forming apparatus. The image forming apparatus is an MFP (Multi-Function Peripherals) 100 that is a complex machine, a printer, a copy machine or the like, for example. In FIG. 1, the MFP 100 is taken an example of the image forming apparatus and will be described below.

The MPF 100 has an auto document feeder (ADF: Auto Document Feeder) 12, an operation panel 13, a scanner 16, a printer portion 17, sheet cassettes (sheet cassettes) 18 and a discharged sheet tray 39.

The ADF 12 is provided on a document table in the openable and closable manner, and automatically conveys a document. The operation panel 13 has an operating portion 14 having various keys and a display 15.

The scanner 16 is provided at the under portion of the ADF 12, and reads a document which is sent by the ADF 12 or a document which is placed on the document table to thereby generate image data. The scanner 16 is an example of an input portion for print document, and besides this, it is possible to receive a document made up by a PC (Personal Computer) serving as an external terminal, for example, in an input portion including an I/F (not shown) for external input and then to print as image data.

The sheet cassettes 18 has a plurality of cassettes 18 to house sheets S with various sizes, respectively. The discharged sheet tray 39 houses the sheet S on which an image has been formed and discharged.

The printer portion 17 includes photoconductive drums and lasers and so on, and processes the image data which has been read with the scanner 16 or the image data which has been made up with PC and so on and thereby forms an image on the sheet S (printing process). The sheet on which the image has been formed by the printer portion 17 is discharged to the discharged sheet tray 39. The printer portion 17 is a color laser printer of a tandem system, for example, and scans image carriers (photoconductive drums) of image forming portions by image lights from an optical scanning device 19, respectively, to thereby form an image.

The printer portion 17 includes image forming portions 20Y, 20M, 20C and 20K of respective colors of yellow (Y), magenta (M), cyan (c) and black (K). The image forming portions 20Y, 20M, 20C and 20K are arranged side by side at the downside of an intermediate transfer belt 21 from the upstream side to the downstream side.

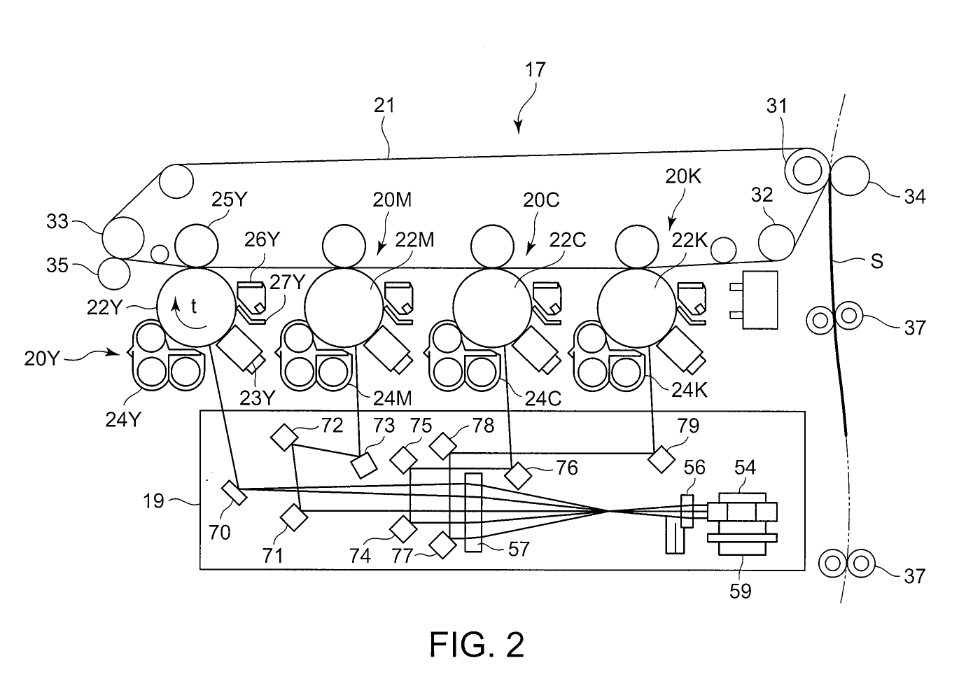

The printer portion 17 including the image forming portions 20Y, 20M, 20C and 20K is enlarged in FIG. 2. In the following description, since the image forming portions 20Y (yellow), 20M (magenta), 20C (cyan) and 20K (black) of the respective colors have the same construction, the construction and action of the image forming portion 20Y will be described as a representative of them.

The image forming portion 20Y has a photoconductive drum 22Y serving as an image carrier, and around the photoconductive drum 22Y, a charger 23Y, a developing device 24Y, a primary transfer roller 25Y, a cleaner 26Y and a cleaning blade 27 are arranged along a rotation direction t. Image light modulated with the image data corresponding to yellow is irradiated for scanning from the optical scanning device 19 on the exposure position of the photoconductive drum 22Y, to thereby form an electrostatic latent image on the rotation driven photoconductive drum 22Y.

The charger 23Y of the image forming portion 20Y uniformly charges the whole surface of the photoconductive drum 22Y. The developing device 24Y feeds yellow toner on the photoconductive drum 22Y by a developing roller to which a developing bias is applied. The cleaner 26Y removes residual toner on the surface of the photoconductive drum 22Y using the cleaning blade 27Y.

At the upper portions of the image forming portions 20Y, 20M, 20C and 20K, a toner cartridge 28 (FIG. 1) to supply toners to the respective developing devices 24Y, 24M, 24C and 24K is provided. In the toner cartridge 28, toner cartridges 28Y, 28M, 28C and 28K of respective colors of yellow (Y), magenta (M), cyan (C) and black (K) are placed side by side.

The intermediate transfer belt 21 is wound around a drive roller 31, and driven rollers 32 and 33. The intermediate transfer belt 21 faces and makes contact with the photoconductive drums 22Y-22K, and moves in the circulating manner. At the position of the intermediate transfer belt 21 facing the photoconductive drum 22Y, primary transfer voltage is applied by a primary transfer roller 25Y, so that the toner image on the photoconductive drum 22Y is primarily transferred to the intermediate transfer belt 21.

A secondary transfer roller 34 is arranged to face the driven roller 31 around which the intermediate transfer belt 21 is wound. When the sheet S passes between the intermediate transfer belt 21 and the secondary transfer roller 34, secondary transfer voltage is applied to the sheet S by the secondary transfer roller 34. A belt cleaner 35 is provided in the vicinity of the driven roller 33 of the intermediate transfer belt 21.

On the other hand, the optical scanning device 19 irradiates for scanning the photoconductive drums 22Y-22K with the respective image lights corresponding to the image information. The electrostatic latent images corresponding to the colors to be developed are formed on the photoconductive drums 22Y-22K with the image lights, respectively. The optical scanning device 19 will be described later.

As shown in FIG. 1, at the place from the sheet cassettes 18 to the secondary transfer roller 34, a separation roller 36 to take out the sheet S inside the sheet cassette 38 and a conveying roller 37 are provided, and a fixing device 38 is provided at the downstream of the secondary transfer roller 34. In addition, the discharged sheet tray 39 is provided at the downstream of the fixing device 38.

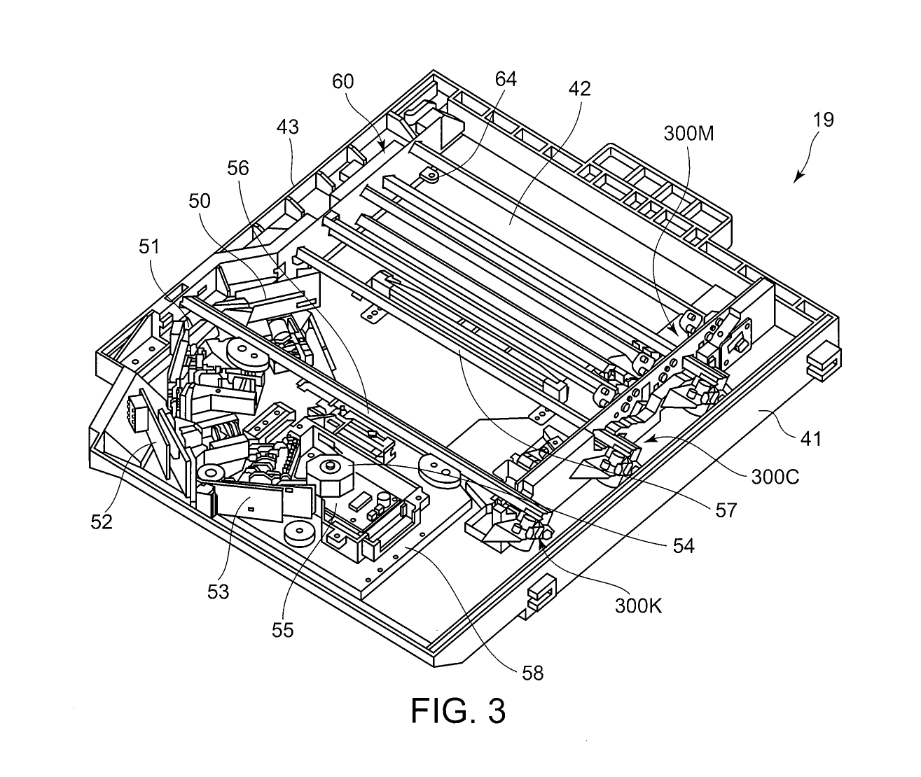

FIG. 3 is a perspective view showing the general structure of the optical scanning device 19. The optical scanning device 19 has a casing 41. The casing 41 includes a bottom portion 42 and a sidewall 43 which uprises from the bottom portion 42, and is integrally formed with synthetic resin, for example.

An upper surface of the casing 41 is covered with a cover. FIG. 3 shows the state in which the cover is uncovered for convenience of description. Optical sources 50, 51, 52 and 53, a polygon mirror structure including a polygon mirror 54, a first deflection lens 56, a second deflection lens 57 and a mirror unit 60 are housed inside the casing 41.

Each of the optical sources 50-53 is provided with a laser diode to output color separated image light (laser beam) toward the polygon mirror 54. The optical sources 50-53, the polygon mirror structure 55, the first deflection lens 56 are mounted in a common base 58 made of aluminium alloy, for example. The polygon mirror 54 is rotated by a polygon motor (not shown), and composes a deflection portion to deflect the image light in the main scanning direction.

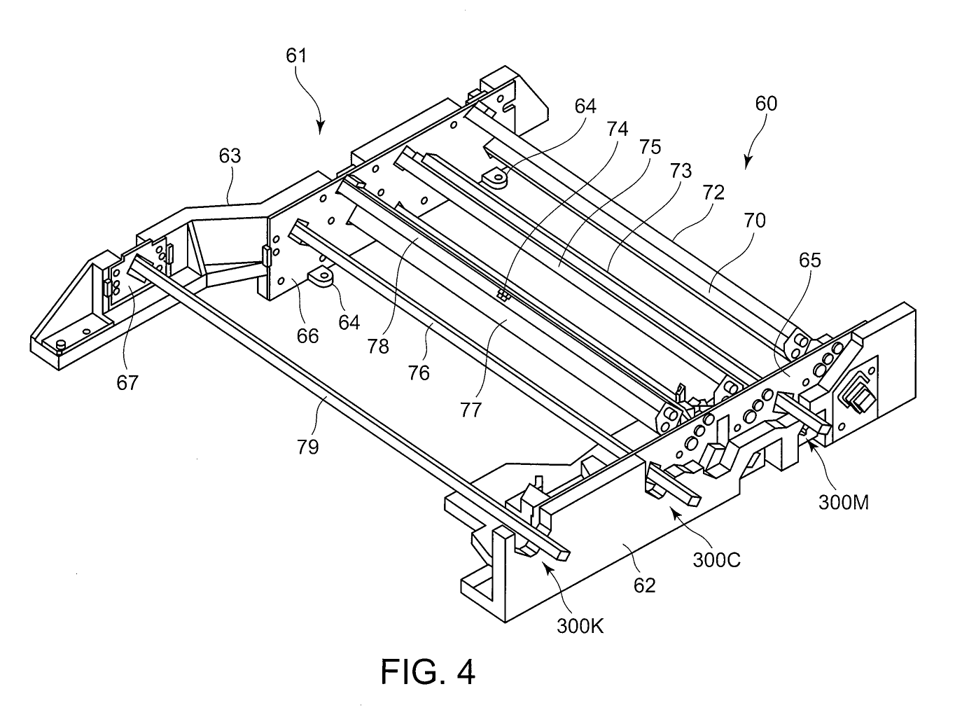

FIG. 4 is a perspective view of the mirror unit 60 which is seen from the polygon mirror 54 side. The mirror unit 60 is provided with a metal frame 61 and return mirrors 70-79 held by the frame 61. The return mirrors 70-79 (hereinafter, simply called mirrors) reflect image lights corresponding to respective colors (yellow, magenta, cyan and black) as shown in FIG. 2.

For example, the mirror 70 reflects the image light for yellow. The mirrors 71, 72 and 73 reflect the image light for magenta. The mirrors 74, 75 and 76 reflect the image light for cyan. The mirrors 77, 78 and 79 reflect the image light for black. Each of the mirrors 70-79 is in the shape of a rod. The mirrors 70-75 are at positions remote from the polygon mirror 54, and the mirrors 76-79 are at positions near the polygon mirror 54.

The frame 61 of the mirror unit 60 includes a pair of base members 62 and 63 made of aluminium alloy, for example. Each of the base members 62 and 63 is formed by casting metal such as aluminium alloy, and is made of aluminium die casting, for example. The base members 62 and 63 are arranged to face each other, and a plurality of affixing portions 64 are provided at the lower portions of the base members 62 and 63, respectively. The affixing portions 64 are fixed to the bottom portion 42 of the casing 41 with fixing members such as bolts.

In addition, as shown in FIG. 4, a first mirror support plate 65 is fitted on the inside surface of the end portion of one base member 62, and a second mirror support plate 66 and a third mirror support plate 67 are fitted on the inside surface of the other base member 63. The mirror support plates 65 and 66 are arranged in parallel with each other. Each of the mirror support plates 65-67 is a metal flat plate with a constant thickness.

With respect to each of the mirrors at the final stage which reflect the image lights of the respective colors, one end portion thereof is fixed to a fulcrum and the other end portion thereof is movable. Hereinafter, the end portion to which the mirror is fixed is called a fixed end portion, and the end portion at the side opposite to the fixed end portion which is movable is called a movable end portion. Correction portions 300M, 300C and 300K which correct tilts of the respective image lights are located at the movable end portions of the mirrors. That is, the correction portion 300M is located at the movable end portion of the mirror 73 which reflects the magenta image light, the correction portion 300C is located at the movable end portion of the mirror 76 which reflects the cyan image light, and the correction portion 300K is located at the movable end portion of the mirror 79 which reflects the black image light. Though the above-described mirror 70 which reflects the yellow image light is not provided with the correction portion at the one end portion unlike the mirrors 73, 76 and 79, the correction portion may be provided at the one end portion in the same way as the mirrors 73, 76 and 79.

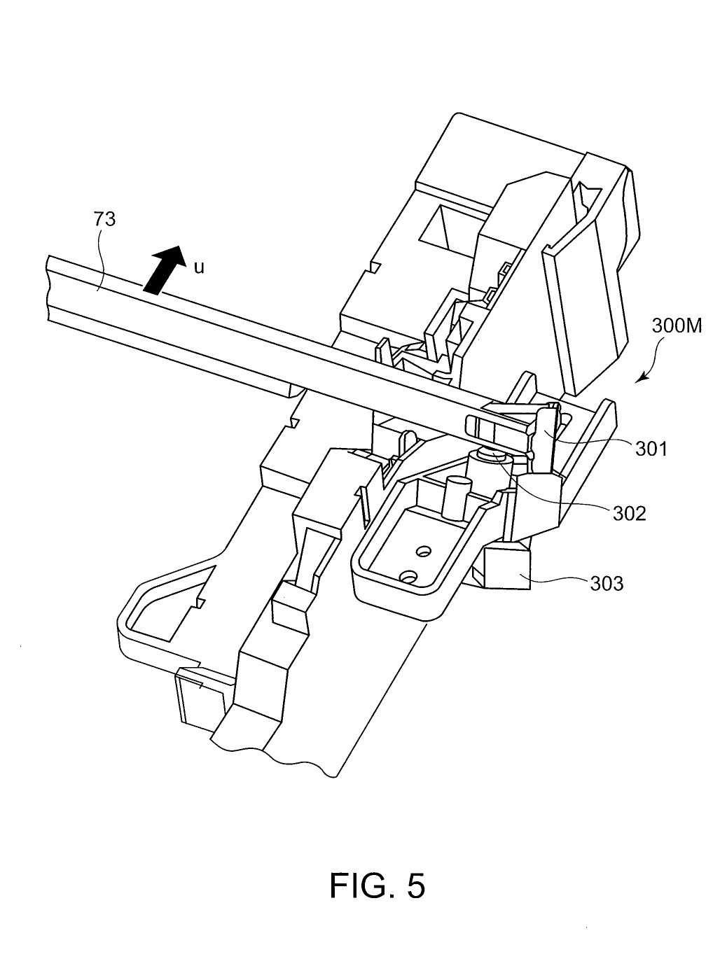

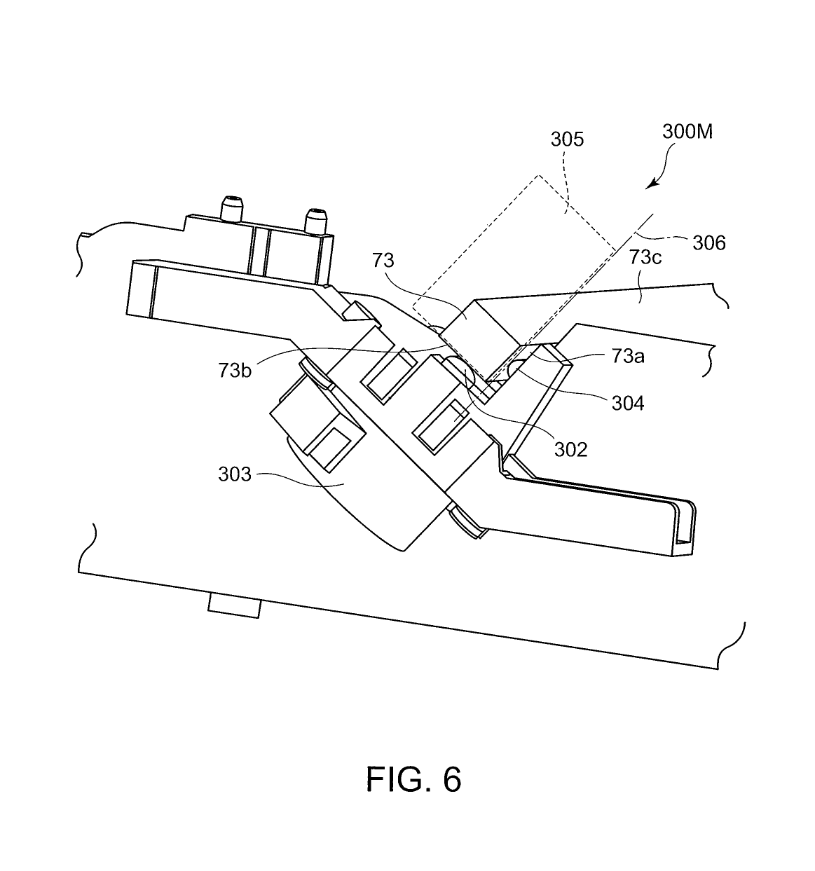

FIG. 5 is a perspective view of the correction portion 300M, and FIG. 6 is a side view of the correction portion 300M. The correction portions 300M, 300C and 300K which are provided at the movable end portions of the mirrors 73, 76 and 79 at the final stage which respectively reflect the magenta, cyan and black image lights have the same structure. Here, the correction portion 300M provided at the end portion of the mirror 73 which reflects the magenta image light will be described.

The correction portion 300M has a plate spring (a third support portion) 301 which presses the mirror 73 from an upper surface (a third surface) 73c in the direction opposite to the mirror reflection direction and presses the one side surface of the mirror 73, a projecting portion (a second support portion) 302 which projects a bottom surface (a second surface) 73b of the mirror 73 in the mirror reflection direction, a correction motor 303 which is a drive portion to move the projecting portion 302, and a projection (a first support portion) 304 which supports the other side surface (a first surface) 73a of the mirror 73 which is not pressed by the plate spring 301. An arrow u in FIG. 5 indicates the mirror reflection direction.

The plate spring 301 presses the mirror 73 from the upper surface (the third surface) 73c in the direction opposite to the mirror reflection direction and presses the one side surface of the mirror 73, and thereby determines the position of the mirror 73. The plate spring 301 is not an integrated type as described above which presses the upper surface (the third surface) 73c and the side surface of the mirror 73, but a plate spring which presses the mirror 73 from the upper surface (the third surface) 73c in the direction opposite to the mirror reflection direction and another plate spring which presses the one side surface of the mirror 73 may be provided so as to press the mirror 73.

The projecting portion 302 projects the mirror 73 from the bottom surface (the second surface) 73b in the mirror reflection direction and is moved by the correction motor 303. That is, the projecting portion 302 is moved by the correction motor 303 in the direction of the arrow u that is the mirror reflection direction and the direction opposite to the direction of the arrow u. The reflection direction of the mirror 73 is adjusted by the movement of the projecting portion 302.

The correction motor 303 is a stepping motor, for example. The correction motor 303 is driven to cause the projecting portion 302 to be moved.

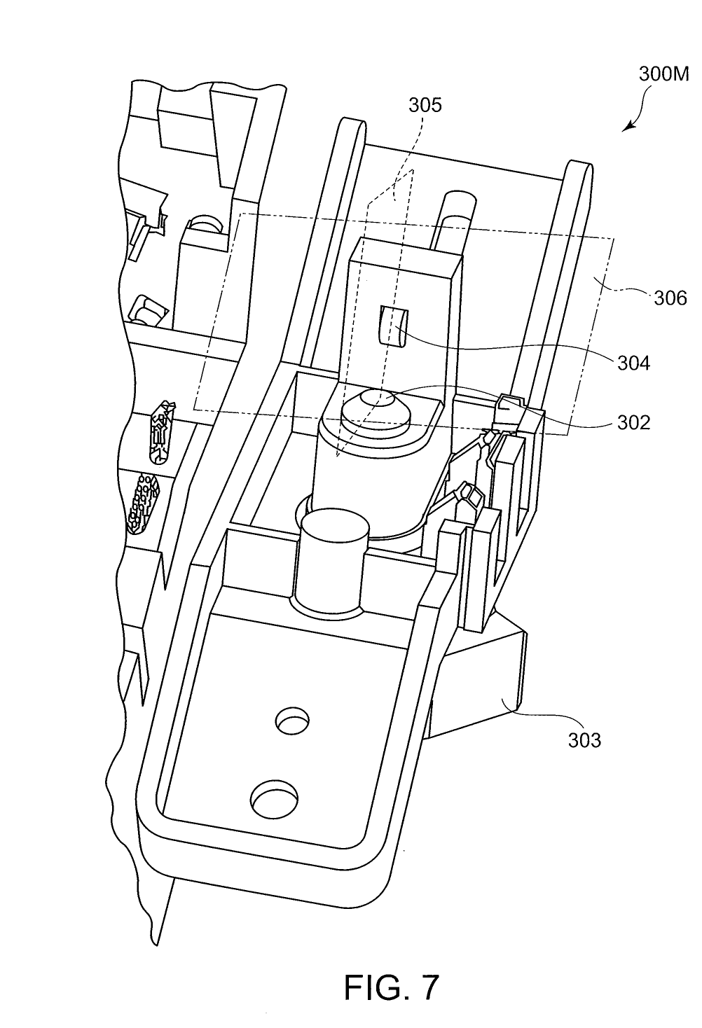

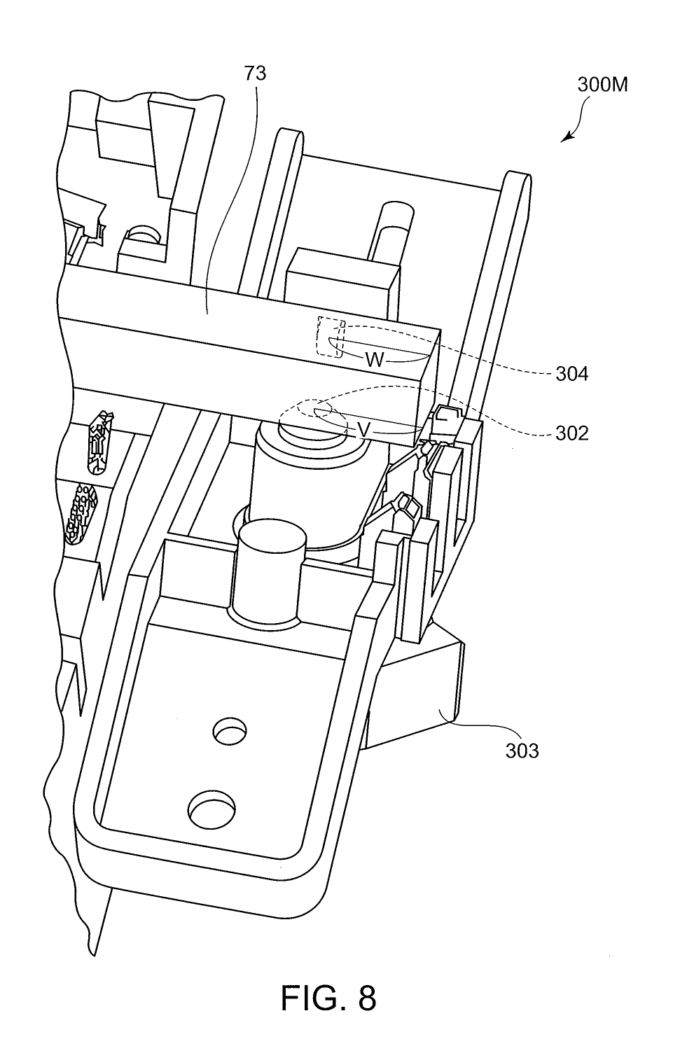

FIG. 7 is an enlarged view of the correction portion 300M in the state in which the mirror 73 is removed, and FIG. 8 is an enlarged view of the correction portion 300M in the state in which the mirror 73 is present. The mirror 73 in FIG. 7 is removed for convenience of description. Here, a virtual face 305 is assumed which is orthogonal to the center of the projection 304 to support the mirror side surface (the first surface) 73a. When a virtual face 306 including the center of the projection 304 is assumed, the virtual face 305 is the face extending diagonally in front in FIG. 7 from the virtual face 306. The virtual face 306 including the center of the projection 304 and the virtual face 305 extending diagonally in front in FIG. 7 from the virtual face 306 form a right angle. At this time, the virtual face 305 includes the center of the projection 304 to support the mirror side surface (the first surface) 73a, and the center of the projecting portion 302 to support the mirror 73 from the bottom surface (the second surface) 73b of the mirror 73.

In addition, the positions of the projecting portion 302 and the projection 304 conform to each other in the longitudinal direction of the mirror 73. That is, in FIG. 8, a length v from the movable end portion of the mirror 73 to a position where the projecting portion 302 contacts with the mirror 73 confirms to a length w from the movable end portion of the mirror 73 to a position where the projection 304 contacts with the mirror 73. In addition, a length from the fixed end portion of the mirror 73 to the position where the projecting portion 302 contacts with the mirror 73 confirms to a length from the fixed end portion of the mirror 73 to the position where the projection 304 contacts with the mirror 73. The positions of the projecting portion 302 and the projection 304 are made to be confirmed to each other in the longitudinal direction of the mirror 73, and the mirror 73 is fixed by applying load with the plate spring 301 from the surfaces opposite to the surfaces of the mirror 73 with which the projecting portion 302 and the projection 304 contact, respectively.

Here, a case is assumed in which the position of the projecting portion 302 to support the bottom surface of the mirror 73 does not conform to the position of the projection 304 to support the side surface of the mirror 73 in the longitudinal direction of the mirror 73, and the position of the projection 304 is at an inner side from the position of the projecting portion 302 in the longitudinal direction of the mirror 73. At this time, the correction motor 303 is located at the end portion side in the longitudinal direction of the mirror 73 than the position of the projection 304. When the vibration of the image forming apparatus 100 during the operation is applied in this state, the correction motor 303 is likely to swing, and the vibration is transmitted to the mirror 73.

On the other hand, in the image forming apparatus 100 having the optical scanning device 19 stated in the first embodiment, the positions of the projecting portion 302 and the projection 304 which support the mirror 73 conform to each other in the longitudinal direction of the mirror 73. The positions of the projecting portion 302 and the projection 304 in the longitudinal direction of the mirror 73 are made to be conformed to each other, and the mirror 73 is fixed by applying load with the plate spring 301 from the surfaces opposite to the surfaces of the mirror 73 with which the projecting portion 302 and the projection 304 contact, respectively, and thereby the vibration which is transmitted to the mirror 73 can be prevented.

With the optical scanning device as described above, when the image forming apparatus is operated, the vibration which is transmitted to the mirror can be prevented.

### Second Embodiment

In an optical scanning device provided in an image forming apparatus of a second embodiment, positions of a projecting portion to support an upper surface of a mirror and a projection to support a side surface of the mirror conform to each other in the longitudinal direction of the mirror. The same symbols are given to the same constituent portions as in the first embodiment.

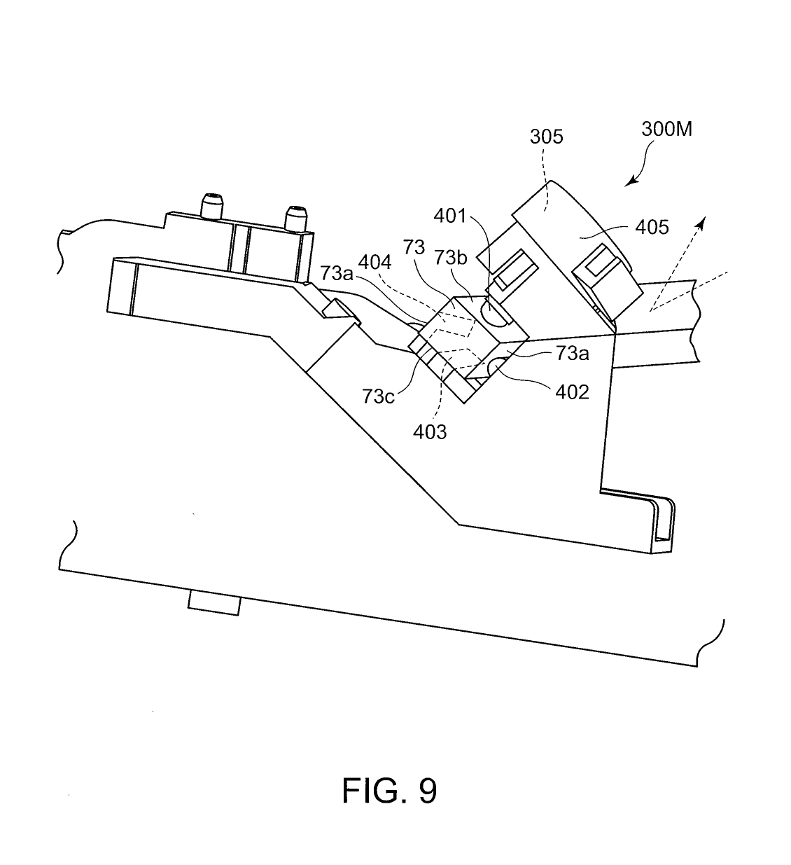

FIG. 9 is a side view of the correction portion 300M. The correction portion 300M has a projecting portion (a second support portion) 401 which presses the mirror 73 from an upper surface (a second surface) 73b in the direction opposite to the mirror reflection direction, a projection (a first support portion) 402 to support the one side surface (the first surface) 73a of the mirror, a plate spring (a third support portion) 403 which supports a bottom surface (a third surface) 73c of the mirror 73 in the mirror reflection direction, a plate spring (a fourth support portion) 404 which supports the other side surface (a fourth surface) 73d of the mirror 73 which is not supported by the projection 402, and a correction motor 405 which moves the projecting portion 401.

In the second embodiment, a virtual face orthogonal to the center of the projecting portion 402 to support the mirror side surface is assumed in the same manner as in the first embodiment. At this time, the virtual face includes the center of the projecting portion 402 to support the mirror side surface and the center of the projecting portion 401 to support the mirror 73 from the upper surface (the second surface) 73b of the mirror 73.

In addition, the positions of the projecting portion 401 and the projection 402 conform to each other in the longitudinal direction of the mirror 73. That is, a length from the movable end portion of the mirror 73 to a position where the projecting portion 401 contacts with the mirror 73 conforms to a length from the movable end portion of the mirror 73 to a position where the projection 402 contacts with the mirror 73. In addition, a length from the fixed end portion of the mirror 73 to the position where the projecting portion 401 contacts with the mirror 73 also conforms to a length from the fixed end portion of the mirror 73 to the position where the projection 402 contacts with the mirror 73. The positions of the projecting portion 401 and the projection 402 in the longitudinal direction of the mirror 73 are made to be conformed to each other, and the mirror 73 is fixed by applying load with the plate spring 403 and the plate spring 404 from the surfaces opposite to the surfaces of the mirror 73 with which the projecting portion 401 and the projection 402 contact. With the construction like this, the vibration transmitted to the mirror 73 can be prevented.

According to the optical scanning device as described above, when the image forming apparatus is operated, the vibration transmitted to the mirror can be prevented. In addition, since the upper surface of the mirror is supported by the projecting portion, and the positions of the projecting portion 401 and the projection 402 in the longitudinal direction of the mirror are made to be conformed to each other, the mirror can be supported in a more stable manner.

While certain embodiments have been described, those embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical scanning device, comprising:
a mirror with one end portion fixed as a fulcrum which reflects a scanning beam, the mirror including at least a first surface, a second surface and a third surface along the longitudinal direction;
a first support portion to support the first surface at the other end portion of the mirror;
a second support portion to support the second surface of the mirror, whose position conforms to a position of the first support portion in the longitudinal direction of the mirror;
a drive portion to drive the second support portion to be moved; and
a third support portion to support the mirror by pressing the third surface of the mirror which is supported by the first support portion and the second support portion.

2. The optical scanning device of claim 1, wherein:
an opposite side of the one end portion of the mirror which is fixed as the fulcrum is a movable end portion.

3. The optical scanning device of claim 2, wherein:
the first support portion, the second support portion and the third support portion are located at the movable end portion side.

4. The optical scanning device of claim 1, wherein:
a position of the third support position conforms to the positions of the first support portion and the second support portion in the longitudinal direction of the mirror.

5. The optical scanning device of claim 2, wherein:
a length from a fixed end portion of the mirror to a position where the first support portion contacts with the mirror conforms to a length from the fixed end portion of the mirror to a position where the second support portion contacts with the mirror.

6. The optical scanning device of claim 2, wherein:
a length from the movable end portion of the mirror to a position where the first support portion contacts with the mirror conforms to a length from the movable end portion of the mirror to a position where the second support portion contacts with the mirror.

7. The optical scanning device of claim 1, wherein:
the second surface is a bottom surface of the mirror, and the second support portion supports the bottom surface and is provided so as to move in the reflection direction of the scanning beam or in a direction opposite to the reflection direction.

8. The optical scanning device of claim 1, wherein:
the second surface is an upper surface of the mirror, and the second support portion supports the upper surface of the mirror and is provided so as to move in the reflection direction of the scanning beam or in a direction opposite to the reflection direction.

9. An image forming apparatus, comprising:
a sheet cassette to feed a recording medium;
a mirror with one end portion fixed as a fulcrum which reflects a scanning beam, the mirror including at least a first, a second and a third surface along the longitudinal direction;
a first support portion to support the first surface at the other end portion of the mirror;
a second support portion to support the second surface of the mirror, whose position conforms to a position of the first support portion in the longitudinal direction of the mirror;
a drive portion to drive the second support portion to be moved;
a third support portion to support the mirror by pressing the third surface of the mirror which is supported by the first support portion and the second support portion.
an image carrier to receive the scanning beam and to form an electrostatic latent image; and
a charger to transfer an image which is obtained by developing the electrostatic latent image to the recording medium fed from the sheet cassette.

10. The image forming apparatus of claim 9, wherein:
an opposite side of the one end portion of the mirror which is fixed as the fulcrum is a movable end portion.

11. The image forming apparatus of claim 10, wherein:
the first support portion, the second support portion and the third support portion are located at the movable end portion side.

12. The image forming apparatus of claim 9, wherein:
a position of the third support position conforms to the positions of the first support portion and the second support portion in the longitudinal direction of the mirror.

13. The image forming apparatus of claim 10, wherein:
a length from a fixed end portion of the mirror to a position where the first support portion contacts with the mirror conforms to a length from the fixed end portion of the mirror to a position where the second support portion contacts with the mirror.

14. The image forming apparatus of claim 10, wherein:
a length from the movable end portion of the mirror to a position where the first support portion contacts with the mirror conforms to a length from the movable end portion of the mirror to a position where the second support portion contacts with the mirror.

15. The image forming apparatus of claim 9, wherein:
the second surface is a bottom surface of the mirror, and the second support portion supports the bottom surface and is provided so as to move in the reflection direction of the scanning beam or in a direction opposite to the reflection direction.

16. The image forming apparatus of claim 9, wherein:
the second surface is an upper surface of the mirror, and the second support portion supports the upper surface of the mirror and is provided so as to move in the reflection direction of the scanning beam or in a direction opposite to the reflection direction.
